(19) United States
(12) Patent Application Publication
(10) Pub. No.: US 2003/0225790 A1
(43) Pub. Date: Dec. 4, 2003

(54) Product inquiry apparatus and a product inquiry method used for inquiring about a product when the product is broken down

(75) Inventor: Masayuki Inoue, Tokyo (JP)

Correspondence Address: Carrier, Blackman & Associates, P.C., 24101 Novi Road #100, Novi, MI, 48375, US

(73) Assignee: Honda Giken Kogyo Kabushiki Kaisha, Tokyo (JP)

(21) Appl. No.: 10/447,124

(22) Filed: May 28, 2003

(30) Foreign Application Priority Data
May 31, 2002 (JP) 2002-159568

(51) Int. Cl. G06F 17/00

(52) U.S. Cl. 707/104.1

(57) ABSTRACT

A product inquiry apparatus includes an inquiry content collector, an inquiry database and a diagnosis data distributor. The inquiry content collector receives an answer data from a first information terminal displaying an inquiry about a trouble of a product and outputs the answer data indicating an answer to the inquiry. The inquiry database stores a plurality of trouble data and a plurality of answer data, wherein each of the plurality of trouble data is related to at least one of the plurality of answer data. The diagnosis data distributor retrieves one indicating the trouble among the plurality of trouble data, based on the answer data and the plurality of answer data, and outputs the first information terminal (9).

### BACKGROUND OF THE INVENTION

1. Field of the Invention

The present invention relates to a product inquiry apparatus and a product inquiry method. More particularly, the present invention relates to the product inquiry apparatus and the product inquiry method that are used for inquiring (taking history) about a product when the product is broken down.

2. Description of the Related Art

Many cars has been repaired widely in the world. A user of a car, when something is wrong with the car, goes to a business office of cars together with the car, and requests to repair the car. At this time, a person in charge of the repair of the car in the business office accepts the request of the user. Next, a repairperson carries out an inquiry (taking history) about the car. The repairperson diagnoses and repairs the car based on the result of the taking history and the inspection result of the car. Then, the repairperson explains the cause of the trouble and the like. It is desired to reduce the number of the repairing steps of the repairperson.

A vehicle diagnosing apparatus is disclosed in Japanese Laid Open Patent Application (JP-A-Showa, 63-103935). The vehicle diagnosing apparatus includes: a knowledge data memory means; a symptom input means; a deducing means; a reporting means; a check condition memory means; a condition change instructing means; and a check controlling means. The knowledge data memory means stores a knowledge data related to a trouble of a vehicle. The symptom input means inputs a symptom, an inspection result and the like. The deducing means deduces a cause of a trouble while retrieving the knowledge data and suitably carrying out a check. The reporting means reports a check result and a deduction result. The check condition memory means stores an already finished check condition until an end of a next step. The condition change instructing means instructs to return the diagnosis condition back to the previous check condition. The check controlling means refers to a content stored in the check condition memory means when a condition change is instructed, and thereby returning the diagnosis condition to the previous condition.

According to such a vehicle diagnosing apparatus, even if an input operation of the inspection result is erroneously performed, it can be again done from the previous check, and it need not be again done from the beginning. Thus, while the previously inspected result is used as its original state, only the erroneous portion can be corrected to thereby attain the trouble diagnosis quickly and surely.

A trouble diagnosing apparatus is disclosed in Japanese Laid Open Patent Application (JP-A-Heisei, 7-71590). The trouble diagnosing apparatus uses at least two of three kinds of knowledge data, when carrying out a trouble diagnosis and investigating the cause of a trouble. The three kinds of data are a check example type knowledge data, a trouble tree analysis type knowledge data, and a trouble mode influence analysis type knowledge data. Such the trouble diagnosing apparatus can obtain a high diagnosis precision without using a knowledge data having a high completion level.

A vehicle diagnosing system disclosed is in Japanese Laid Open Patent Application (JP-A-Heisei, 11-94708). The vehicle diagnosing system, when carrying out a maintenance or a trouble repair of various units in an electrically driving apparatus and a hydraulically driving apparatus, indicates the individual data of a program on a screen of a display means. In the program, a data corresponding to a unit information or a trouble information of the unit and at least one data of an electric circuit data, a hydraulic data and a mount data of the various units are combined and set. According to such a diagnosing system, it is possible to attain not only the maintenance of the unit, the deduction of the trouble cause and the defect reason but also the easy recognition of the position on a circuit or a mount position in the trouble unit that is the trouble portion or the defective portion. And it is thereby possible to smoothly carry out the work without any inferior to a serviceman having a special knowledge.

### SUMMARY OF THE INVENTION

Therefore, an object of the present invention is to provide a product inquiry apparatus and a product inquiry method that reduces the number of steps of a repairperson who repairs a product.

Another object of the present invention is to provide a product inquiry apparatus and a product inquiry method that simplify providing a client with a result of a inquiry (taking history) related to a defective product.

Still another object of the present invention is to provide a product inquiry apparatus and a product inquiry method that simplify inquiring (taking history, check) of a checker (investigator, repairperson and the like).

Yet still another object of the present invention is to provide a product inquiry apparatus and a product inquiry method that enable a checker to properly carry out a inquiry (taking history, check).

It is also an object of the present invention is to provide a product inquiry apparatus and a product inquiry method that enable a designer to design a product in which a defect is not easily induced.

In order to achieve an aspect of the present invention, the present invention provides a product inquiry system including: a first information terminal and a product inquiry apparatus. The first information terminal displays an inquiry about a trouble of a product and outputs an answer data indicating an answer to the inquiry. The product inquiry apparatus stores a plurality of trouble data and a plurality of answer data, each of the plurality of trouble data is related to at least one of a plurality of answer data.

The product inquiry apparatus receives the answer data, retrieves one indicating the trouble among the plurality of trouble data, based on the answer data and the plurality of answer data, and outputs the first information terminal.

The product inquiry system of the present invention further includes a second information terminal. The second information terminal receives and displays the trouble data and outputs a diagnosis trouble data indicating an content of the repair after repairing the product based on the trouble data. The product inquiry apparatus receives the diagnosis trouble data, relates the diagnosis trouble data to the answer data, and stores the diagnosis trouble data and answer data as one of the plurality of trouble data and one of the plurality of answer data, respectively.

The product inquiry system of the present invention further includes a third information terminal. The third information terminal receives and displays the diagnosis trouble data. The product inquiry apparatus outputs one of the plurality of trouble data as the diagnosis trouble data to the third information terminal, when the one of the plurality of trouble data is stored beyond a predetermined frequency.

In the product inquiry system of the present invention, a question of the inquiry is generated by any one of the first information terminal and the product inquiry apparatus.

In order to achieve another aspect of the present invention, the present invention provides a product inquiry apparatus including: an inquiry content collector, an inquiry database and a diagnosis data distributor. The inquiry content collector receives an answer data from a first information terminal displaying an inquiry about a trouble of a product and outputs the answer data indicating an answer to the inquiry. The inquiry database stores a plurality of trouble data and a plurality of answer data, wherein each of the plurality of trouble data is related to at least one of the plurality of answer data. The diagnosis data distributor retrieves one indicating the trouble among the plurality of trouble data, based on the answer data and the plurality of answer data, and outputs the first information terminal.

The product inquiry apparatus of the present invention further includes a diagnosis data collector. The diagnosis data collector receives a diagnosis trouble data indicative of an content of the repair from a second information terminal receiving and displaying the trouble data and outputting the diagnosis trouble data after repairing the product based on the trouble data. It relates the diagnosis trouble data to the answer data, and stores the diagnosis trouble data and answer data as one of the plurality of trouble data and one of the plurality of answer data respectively in the inquiry database.

In the product inquiry apparatus of the present invention, the plurality of trouble data is related to a number of times that each kind of the plurality of trouble data is stored in the inquiry database.

In the product inquiry apparatus of the present invention, the answer data indicates an answer to a question of the inquiry including a kind of the product. The diagnosis data distributor outputs a similar trouble data as the trouble data to the first information terminal when the inquiry database does not store any one of the plurality of trouble data corresponding to the answer data. The similar trouble data is for another kind of a product similar to a kind of the product, and is related to a similar answer data corresponding to the answer data.

The product inquiry apparatus of the present invention further includes a diagnosing unit, which presumes a cause of the trouble in the product based on the answer data, and generates a presumption trouble data. The diagnosis data distributor outputs the presumption trouble data to the first information terminal when the inquiry database does not store any one of the plurality of trouble data corresponding to the answer data.

The product inquiry apparatus of the present invention further includes an inquiry unit that prepares a question of the inquiry and outputs the question to the first information terminal.

The product inquiry apparatus of the present invention further includes a trouble content distributor which outputs one of the plurality of trouble data as a cause of the trouble to a third information terminal, when the cause of the trouble is stored beyond a predetermined frequency. The third information terminal receives and displays the cause of the trouble. In the product inquiry apparatus of the present invention, the product is a car.

In order to achieve still another aspect of the present invention, the present invention provides a product inquiry method including the steps of: (a) receiving an answer data from a first information terminal which displays an inquiry about a trouble of a product and outputs the answer data indicating an answer to the inquiry; (b) retrieving a trouble data indicating the trouble among a plurality of trouble data, based on the answer data and a plurality of answer data; and (c) outputting the trouble data to the first information terminal). The plurality of trouble data and a plurality of answer data are stored in an inquiry database, each of the plurality of trouble data is related to at least one of the plurality of answer data.

The product inquiry method of the present invention further includes the steps of: (d) receiving a diagnosis trouble data from a second information terminal which receives and displays the trouble data and outputs the diagnosis trouble data indicating an content of the repair after repairing the product based on the trouble data; and (e) relating the diagnosis trouble data to the answer data and storing the diagnosis trouble data and answer data as one of the plurality of trouble data and one of the plurality of answer data, respectively in the inquiry database.

In the product inquiry method of the present invention, the plurality of trouble data is related to a number of times that each kind of the plurality of trouble data is stored in the inquiry database.

The product inquiry method of the present invention further includes the step of: (f) outputting a similar trouble data as the trouble data to the first information terminal when the inquiry database does not store any one of the plurality of trouble data corresponding to the answer data. The answer data indicates an answer to a question of the inquiry including a kind of the product. The similar trouble data is for another kind of a product similar to a kind of the product, and is related to a similar answer data corresponding to the answer data.

The product inquiry method of the present invention further includes the step of: (g) presuming a cause of the trouble in the product based on the answer data and generating a presumption trouble data; and (h) outputting the presumption trouble data to the first information terminal when the inquiry database does not store any one of the plurality of trouble data corresponding to the answer data.

The product inquiry method of the present invention further includes the step of: (i) preparing a question of the inquiry and outputting the question to the first information terminal.

The product inquiry method of the present invention further includes the step of: (j) outputting one of the plurality of trouble data as the cause of the trouble to a third information terminal, when the cause of the trouble is stored beyond a predetermined frequency. The third information terminal receives and displays the cause of the trouble.

In the product inquiry method of the present invention, the product is a car.

In order to achieve yet still another aspect of the present invention, the present invention provides a computer program product embodied on a computer-readable medium and including code that, when executed, causes a computer to perform the following: (k) receiving an answer data from a first information terminal which displays an inquiry about a trouble of a product and outputs the answer data indicating an answer to the inquiry; (l) retrieving a trouble data indicating the trouble among a plurality of trouble data, based on the answer data and a plurality of answer data; and (m) outputting the trouble data to the first information terminal. The plurality of trouble data and a plurality of answer data are stored in an inquiry database, each of the plurality of trouble data is related to at least one of the plurality of answer data.

The computer program product of the present invention further includes the steps of: (n) receiving a diagnosis trouble data from a second information terminal which receives and displays the trouble data and outputs the diagnosis trouble data indicating an content of the repair after repairing the product based on the trouble data; and (o) relating the diagnosis trouble data to the answer data and storing the diagnosis trouble data and answer data as one of the plurality of trouble data and one of the plurality of answer data, respectively in the inquiry database.

In the computer program product of the present invention, the plurality of trouble data is related to a number of times that each kind of the plurality of trouble data is stored in the inquiry database.

The computer program product of the present invention further includes the step of: (p) outputting a similar trouble data as the trouble data to the first information terminal when the inquiry database does not store any one of the plurality of trouble data corresponding to the answer data. The answer data indicates an answer to a question of the inquiry including a kind of the product. The similar trouble data is for another kind of a product similar to a kind of the product, and is related to a similar answer data corresponding to the answer data.

The computer program product of the present invention further includes the step of: (q) presuming a cause of the trouble in the product based on the answer data and generating a presumption trouble data; and (r) outputting the presumption trouble data to the first information terminal when the inquiry database does not store any one of the plurality of trouble data corresponding to the answer data.

The computer program product of the present invention further includes the step of: (s) preparing a question of the inquiry and outputting the question to the first information terminal.

The computer program product of the present invention further includes the step of: (t) outputting one of the plurality of trouble data as the cause of the trouble to a third information terminal, when the cause of the trouble is stored beyond a predetermined frequency. The third information terminal receives and displays the cause of the trouble.

In the computer program product of the present invention, the product is a car.

### BRIEF DESCRIPTION OF THE DRAWINGS

FIG. 1 is a block diagram showing an embodiment of a vehicle inquiry system;

FIG. 2 is a block diagram showing an embodiment of a vehicle inquiry apparatus according to the present invention;

FIG. 3 is a view showing an embodiment of a inquiry database;

FIG. 4 is a flowchart showing an embodiment of a inquiring (history taking, check) operation;

FIG. 5 is a flowchart showing an embodiment of an operation for repairing a car;

FIG. 6A is a view showing another embodiment of a business office server; and

FIG. 6B is a view showing another embodiment of a checker PDA.

### DESCRIPTION OF THE PREFERRED EMBODIMENT

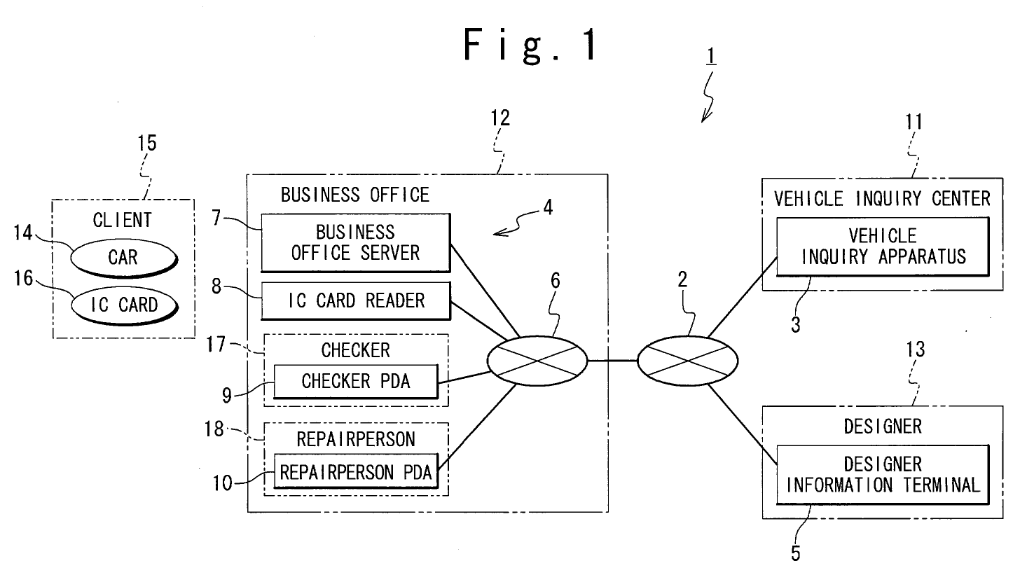

With reference to the attached drawings, a product inquiry apparatus according to the present invention is described by exemplifying an embodiment of a vehicle (as a product) inquiry apparatus used when a trouble of a car is checked, carried out an inquiring (history taking) and diagnosed. That vehicle inquiry apparatus 3 is applied to a vehicle inquiry system 1, as shown in FIG. 1. The vehicle inquiry system 1 includes the vehicle inquiry apparatus 3, a business office system 4 and a designer terminal 5. In the vehicle inquiry system 1, the vehicle inquiry apparatus 3 is connected to a plurality of information (data) processors (computers) such that it can send data (information) in two ways through the Internet 2 (and a wireless LAN 6) to the plurality of information (data) processors. The plurality of information (data) processors is included in a business office system 4 and a designer terminal 5.

The vehicle inquiry apparatus 3 is the information (data) processor exemplified as a workstation, and it belongs to a vehicle inquiry center 11. The designer terminal 5 is exemplified as a personal computer, and it belongs to a designer 13. The business office system 4 belongs to a business office 12, and the plurality of information (data) processors is connected in two ways through the wireless LAN 6 to one another. The plurality of information (data) processors includes a business office server 7, an IC card reader 8, a checker portable terminal (hereafter, abbreviated as [PDA] in this specification) 9 and a repairperson PDA 10. The checker PDA 9 and the repairperson PDA 10 are the small and portable information (data) processors such as personal digital assistants, portable telephones and the like.

The business office 12 includes a shop for selling a car 14 to a client 15; and a repairing factory for repairing the car 14. A checker 17 belongs to the shop, and a repairperson 18 belongs to the repairing factory. The checker PDA 9 is used by the checker 17, and the repairperson PDA 10 is used by the repairperson 18.

The client 15 has an IC card 16 together with the car 14. The IC card 16 records a personal data to identify the client 15 and a vehicle data to identify the car 14. The personal data includes a name of the client 15, an address, a date of birth, a zip code, a telephone number, an e-mail address, a family configuration and an annual income. The vehicle data includes a vehicle number of the car 14, a registration date, a model year, a number of doors, a mission type and a repair inspection history. The client 15, when something is wrong with the car 14, requests the business office 12 to repair the car 14.

An IC card reader 8, when the IC card 16 is inserted, reads the personal data and the vehicle data that are noted in the IC card 16. The checker 17 use the checker PDA 9 to send the defective symptom of the car 14 and the answer of the inquiring (history taking, check) of the client 15 to the vehicle inquiry apparatus 3. Then, the checker 17 reads the cause of the defect and the repairing method of the car 14 displayed on the checker PDA 9, distributed by the vehicle inquiry apparatus 3. The repairperson 18 repairs the car 14 based on the cause and the repairing method sent by the checker 17. Moreover, the repairperson 18 uses the repairperson PDA 10 and then sends the repair content performed on the car 14 to the vehicle inquiry apparatus 3.

The vehicle inquiry center 11 collects the inquiring (history taking, check) result and the repair content from the business office 12, by using the vehicle inquiry apparatus 3. Then, the vehicle inquiry center 11 provides the properly inquiring (history taking, check) based on the inquiring (history taking, check) result to the business office 12. The vehicle inquiry center 11 further provides the data related to the frequently induced trouble to the designer 13.

The designer 13 designs a car 15, and further uses the designer terminal 5. The designer 13 refers to the data related to the trouble provided from the vehicle inquiry center 11, and then designs the car 14 in which a trouble is not easily induced. Incidentally, the designer 13 can be applied to a person who designs a part constituting the car 14. At this time, the designer 13 refers to the data related to the trouble provided from the vehicle inquiry center 11, and thereby designs the part in which a trouble is not easily induced.

The business office server 7 has a computer program for managing a stock of a part, a computer program for ordering a part and a computer program for estimating a repair. That is, the business office server 7 collects the content of the repair from the checker PDA 9 or the repairperson PDA 10, and confirms whether or not the part (including a tool) necessary for the repair is stocked. The business office server 7 also orders the part if it's necessary, and estimates the cost of the repair, and then sends the estimated cost back to the checker PDA 9 or the repair person PDA 10.

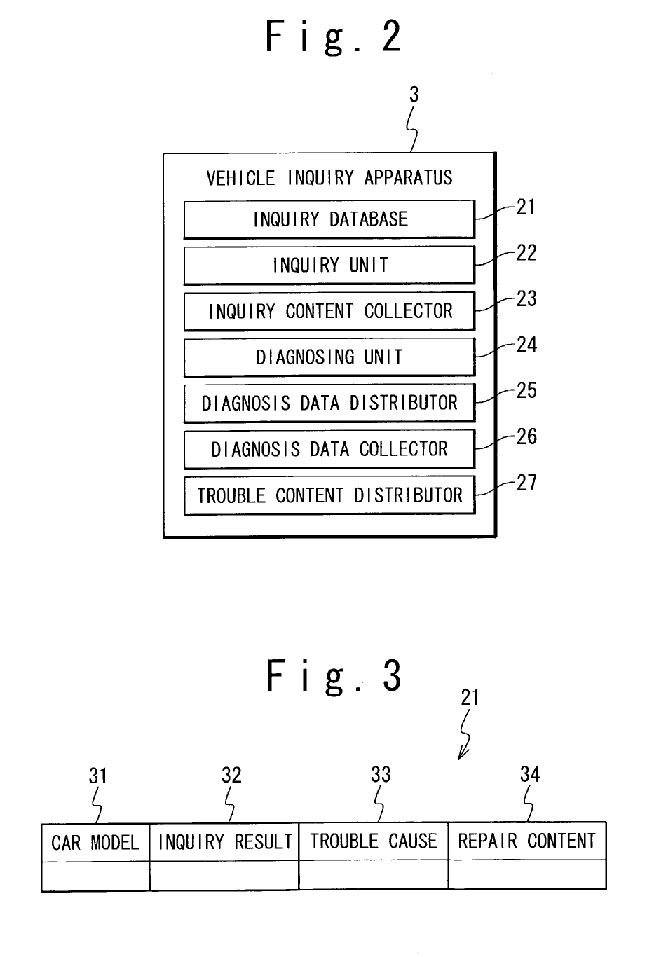

FIG. 2 shows the vehicle inquiry apparatus 3 in detail. The vehicle inquiry apparatus 3 includes computer programs. The computer programs includes an inquiry database 21, an inquiry unit 22, an inquiry content collector 23, a diagnosing unit 24, a diagnosis data distributor 25, a diagnosis data collector 26 and a trouble content distributor 27.

The inquiry database 21 records the inquiring (history taking, check) result performed on the client 15 and the repair content, for each repair performed on the car 14 by the business office 12. Then, the inquiry database 21 retrieves and outputs the data requested by the other program computer. The inquiry database 21 further records the data outputted from the other computer program.

The inquiry unit 22 collects the symptom of the defective car 14 from the checker PDA 9, and prepares a plurality of questions to point out the defective portion of the car 14. Then, the inquiry unit 22 distributes to the checker PDA 9. That is, the inquiry unit 22 firstly prepares the questions to inquire (check) the symptoms (abnormal noise, abnormal vibration and the like) induced in the car 14 and distributes to the checker PDA 9. Then, the inquiry unit 22 prepares a next question based on the answers of the above-mentioned questions and again distributes to the checker PDA 9. For example, as the questions about the car 14 in which the abnormal noise is made, there are exemplified “Has an inspection been done in a few days?”, “Is there an impact experience?”, “Do you feel static electricity when an abnormal noise is made?”, “Is an abnormal noise made when oil is supplied?”, “When an abnormal noise is made, what is a speed?”, “When an abnormal noise is made, what are road surface and topography?”, “When an abnormal noise is made, what are step degrees of an acceleration pedal, a brake pedal and a clutch pedal?”, “When an abnormal noise is made, what is a time band?” “When an abnormal noise is made, what is an idle condition?”, “When an abnormal noise is made, what is weather?”, “What is a usage gasoline?”, “What is a usage oil?”, “What is a usage addition agent?”, “What is a turned degree of a handle in which an abnormal noise is made?”, “Is there any shock feeling such as jerk and the like?”, “What is a shift position at which an abnormal noise is made?”, “What type (kind) of the tires do you use?”, “How much is a size of the tires?” and “Which manufacturer the tires is made?”.

The inquiry content collector 23 collects the content answered by the client 15 about the inquiry (history taking, check) from the checker 17 from the checker PDA 9 through the Internet 2. The inquiry content collector 23 records that content in the inquiry database 21.

The diagnosing unit 24 finds out the trouble portion and the repairing method based on the inquiry (history taking, check) result collected by the inquiry content collector 23. At this time, the diagnosing unit 24 finds out the trouble portion and the repairing method without using the inquiry database 21. The diagnosing unit 24 further points out the trouble portion in accordance with the inspection result collected from the repair person PDA 10, and finds out the repairing method. Such the diagnosing unit 24 is well known.

The diagnosis data distributor 25 refers to the inquiry database 21 and distributes to the checker PDA 9 the content of the repair corresponding to the result of the inquiry (history taking, check) collected from the inquiry content collector 23. The diagnosis data distributor 25, if there are a plurality of repair contents, further assigns apriority to the plurality of repair contents, in an order of reducing the frequency recorded in the inquiry database 21, and distributes to the checker PDA 9. The diagnosis data distributor 25, if the inquiry database 21 does not record the corresponding treatment data, distributes the repairing method found out by the diagnosing unit 24, to the checker PDA 9.

The diagnosis data collector 26 collects the repair content performed on the car 14 from the repair person PDA 10, and relates the repair content to the inquiry (history taking, check) result collected from the inquiry content collector 23, and records them in the inquiry database 21. That repair content further represents the trouble induced in the car and the portion thereof.

The trouble content distributor 27, when the inquiry database 21 records one trouble beyond a predetermined number of times, distributes the data indicative of its fact to the designer terminal 5.

FIG. 3 shows the inquiry database 21 in detail. The inquiry database 21 stores (records) an inquiry (history taking, check) diagnosis data generated for each repair carried out in the business office 12. The inquiry (history taking, check) diagnosis data relates an answer data related to an inquiry (history taking, check) done in one repair to a trouble data. The answer data is composed of a car model 31 and an inquiry (history taking, check) result 32. The trouble data is composed of a trouble cause 33 and a repair content 34. The car model 31 identifies the kind of the car 14. As for the car 14, even in a case of the same car model, the specification is different depending on a model year, and different depending on a sale territory (country). The car model 31 also identifies such a detailed difference. The check result 32 relates a plurality of answers to a plurality of questions and represents them. The plurality of questions is the questions prepared by the inquiry unit 22, and the plurality of answers is the answers of the client 15 to the questions. That is, the check result 32 represents the symptom induced in the car 14. The trouble cause 33 represents the cause of the symptom induced in the car 14 diagnosed by the repairperson 18. The repair content 34 represents the content of the repair performed on the car 14 by the repairperson 18.

The product inquiring method according to the present invention will be described below by exemplifying an embodiment of a vehicle inquiring method used in a case of an inquiry (history taking, check) and a diagnosis for a trouble of a car. The vehicle inquiring method is carried out by the vehicle inquiry system 1. The vehicle inquiring method includes the operation for receiving the request of the repair of the car 14 from the client 15, the operation for inquiring (history taking, checking) to the client 15 for the car 14, the operation for repairing the car 14, and the operation for reporting the trouble cause to the designer 13.

The business office 12, when diagnosing and repairing the trouble of the car 14, firstly receives the request of the repair of the car 14 from the client 15.

The client 15 , who perceives the defect of the car 14, firstly goes to the business office 12 together with the car 14, or goes to the business office 12 after communicating with the business office 12 through a telephone or the like. The client 15 tells a staff of the business office 12 about the request of the repair of the car 14 at an entrance of the business office 12, and delivers the IC card 16 by hand. The staff uses the IC card reader 8, reads the personal data of the client 15 and the vehicle data of the car 14 from the IC card 16. Next, the staff (or the business office server 7) distributes the personal data and the vehicle data to the checker PDA 9 of the checker 17 in charge of the reception for the client 15. Then, the staff introduces the client 15 and the car 14 to a parking position. The checker 17 asks the client 15 about the condition of the car 14 (carried out a history taking, inquiry, checks) at the parking position.

Incidentally, the client 15 can request to repair the car 14 without the IC card 16. At this time, the client 15 together with the car 14 is introduced to the parking position. The checker 17 asks the client 15 about the condition of the car 14 (carried out a history taking, inquiry, checks) at the parking position. Moreover, the client 15 can call the checker 17 to a predetermined place and receive the inquiry (history taking, check) without going to the business office 12 together with the car 14.

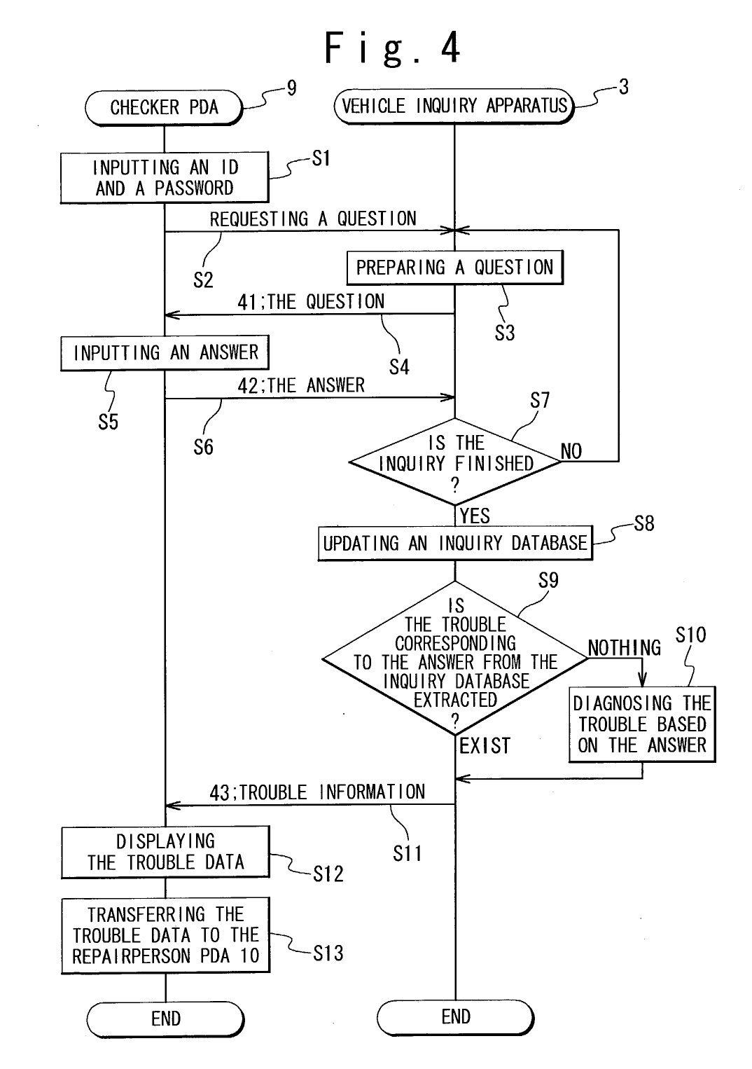

FIG. 4 shows the operation for inquiring (history taking, checking) to the client 15 for the car 14. The checker 17 firstly inputs an ID and a password, which are assigned to him or her, to the checker PDA 9 (Step S1) and activates the computer program to use the vehicle inquiry system 1. The checker 17 further asks the client 15 about the defective symptom of the car 14 (carried out a history taking, inquiry, checks), and inputs to the checker PDA 9. The checker PDA 9 sends the vehicle data of the car 14 and the symptom thereof to the vehicle inquiry apparatus 3 and requests a question for the inquiry (history taking, check)(Step S2).

The vehicle inquiry apparatus 3 prepares a question 41 based on the received vehicle data and the symptom thereof (Step S3) and sends the question 41 back to the checker PDA 9 (Step S4). The checker PDA 9 receives and displays the question 41. The checker 17 asks the client about the question 41 received by the checker PDA 9, and inputs an answer 42 for the question 41 to the checker PDA 9 (Step S5). The checker PDA 9 sends the input answer 42 to the vehicle inquiry apparatus 3 (Step S6).

The vehicle inquiry apparatus 3 repeatedly prepares a next question 41 based on the answer 42 (Step S3) and sends to the checker PDA 9 (Step S3). The vehicle inquiry apparatus 3, if the answers 42 to the questions 41 for the inquiry (history taking, check) is sufficiently collected (Step S7; YES), ends the preparation for the question 41. Then, the vehicle inquiry apparatus 3 stores (records) the answers 42 in the inquiry database 21 (step S8).

The vehicle inquiry apparatus 3 extracts the trouble data corresponding to the answer data (inquiring result) indicating the car model of the car 14 and the answer to the inquiry (history taking, check) from the inquiry database 21 (Step S9). The vehicle inquiry apparatus 3 assigns a priority to the extracted trouble data 43 in an order of reducing a frequency and distributes it to the checker PDA 9 (Step S11). Here, the frequency is a number of times that storing the trouble data and the answer data in the inquiry database 21 in the step S8.

If the vehicle inquiry apparatus 3 can not extract the trouble data corresponding to the answer data, it extracts the trouble data based on the answer data after the replacement by the car model similar to the car 14. Then, the vehicle inquiry apparatus 3 assigns the priority to the extracted trouble data in the order of reducing the frequency, and distributes to the checker PDA 9. If the vehicle inquiry apparatus 3 can not retrieve the trouble data corresponding to the answer even in the case of the similar car model, it automatically diagnoses the trouble of the car 14 based on the answer without using the inquiry database 21 (Step S10). Then, the vehicle inquiry apparatus 3 sends the diagnosis data of the vehicle as the trouble data 43 to the checker PDA 9 (Step S11).

The checker PDA 9 receives and displays the received trouble data (Step S12), and the checker 17 explains the trouble data to the client 15. The checker 17 transfers the trouble data to the repairperson PDA 10 of the repairperson 18 who repairs the car 14 (Step S13). The repairperson PDA 10 receives and displays the trouble data.

According to the above-mentioned operations, even a checker who is shallow in experience can carry out the proper inquiry (history taking, check) similarly to a skilled repairperson. Consequently, this enables the reduction in the number of the steps of the repairperson.

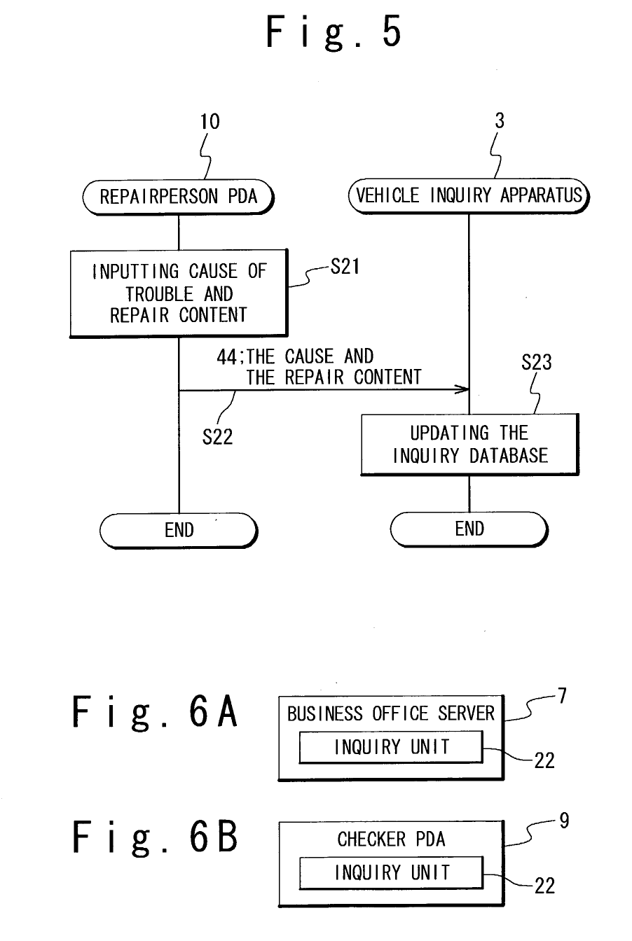

FIG. 5 shows the operation for repairing the car 14. The repairperson 18 firstly obtains the defective symptom of the car 14 from the checker 17, or uses the repairperson PDA 10 to access the vehicle inquiry apparatus 3 and download from the inquiry database 21. The repairperson 18 refers to the data to thereby diagnose and repair the trouble of the car 14. At this time, the repair person 18 uses the repair person PDA 10, sends the inspection result of the car 14 to the vehicle inquiry apparatus 3, and obtains the diagnosis of the vehicle inquiry apparatus 3. Then, the repairperson 18 refers to the data and thereby determines the repair content of the car 14. Moreover, the repairperson 18 uses the repairperson PDA 10, sends the repair content to the business office server 7, and confirms whether or not the part (including the tool) necessary for the repair is stocked. The repairperson 18 orders the part if it's necessary, then estimates the cost of the repair, and thereby obtains the estimated money amount. The repairperson 18, after explaining the client 15 about the repair, repairs the car 14.

The repairperson 18 inputs the cause of the trouble and the repair content as a trouble data 44 to the repairperson PDA 10 (Step S21). The repairperson PDA 10 sends the trouble data 44 (the cause and the repair content) to the vehicle inquiry apparatus 3 (Step S22). The vehicle inquiry apparatus 3 relates the trouble data 44 to the answer data 42 stored in the step S8, and stores (records) the trouble data 44 in the inquiry database 21 (Step S23).

The operation for reporting the trouble cause to the designer 13 is intermittently executed. The vehicle inquiry apparatus 3 intermittently retrieves the trouble in which the number of the trouble exceeds a predetermined number. The vehicle inquiry apparatus 3 reports the retrieved trouble cause to the designer 13. The designer 13 designs the car 14 or the part constituting the car 14 based on the trouble cause.

The above-mentioned report of the trouble cause enables the designer 13 to design the car or the part whose trouble is reduced. Thus, the defect of the car is reduced.

In another embodiment of the vehicle inquiry system 1, the inquiry unit 22 is included in the business office server 7 as shown in FIG. 6A. At this time, the checker PDA 9 asks the business office server 7 the question about the inquiry (history taking, check), and collects the question about the inquiry (history taking, check) from the business office server 7. When the algorithm for preparing the question about the inquiry (history taking, check) is changed, the vehicle inquiry apparatus 3 distributes the changed inquiry unit 22 to the respective business office servers 7. At this time, in the vehicle inquiry apparatus 3, its process amount is dropped. Thus, this embodiment is preferable.

In still another embodiment of the vehicle inquiry system 1, the inquiry unit 22 is included in the checker PDA 9 as shown in FIG. 6B. At this time, the checker 17 asks the client 15 for the question prepared by the checker PDA 9. When the algorithm for preparing the question is changed, the vehicle inquiry apparatus 3 distributes the changed inquiry unit 22 to the checker PDA 9. At this time, in the vehicle inquiry apparatus 3 and the business office server 7, their process amounts are dropped. Thus, this embodiment is preferable. Moreover, the checker 17 can carry out the inquiry (history taking, check) even if the checker PDA 9 is not connected to the Internet 2 or the wireless LAN 6. Thus, this embodiment is preferable.

According to the product inquiry apparatus and the product inquiry method based on the present invention, the checker can check the client easily and properly. As a result, it is possible to reduce the number of the steps in the repairperson.

What is claimed is:

1. A product inquiry system comprising:
a first information terminal which displays an inquiry about a trouble of a product and outputs an answer data indicating an answer to said inquiry; and
a product inquiry apparatus which stores a plurality of trouble data and a plurality of answer data, each of said plurality of trouble data is related to at least one of a plurality of answer data;
wherein said product inquiry apparatus receives said answer data, retrieve one indicating said trouble among said plurality of trouble data, based on said answer data and said plurality of answer data, and outputs said first information terminal.

2. The product inquiry system according to claim 1, further comprising:
a second information terminal which receives and displays said trouble data and outputs a diagnosis trouble data indicating an content of said repair after repairing said product based on said trouble data;
wherein said product inquiry apparatus receives said diagnosis trouble data, relates said diagnosis trouble data to said answer data, and stores said diagnosis trouble data and answer data as one of said plurality of trouble data and one of said plurality of answer data, respectively.

3. The product inquiry system according to claim 2, further comprising:
a third information terminal which receives and displays said diagnosis trouble data;
wherein said product inquiry apparatus outputs one of said plurality of trouble data as said diagnosis trouble data to said third information terminal , when said one of said plurality of trouble data is stored beyond a predetermined frequency.

4. The product inquiry system according to claim 3, wherein a question of said inquiry is generated by any one of said first information terminal and said product inquiry apparatus.

5. A product inquiry apparatus comprising:
a inquiry content collector which receives an answer data from a first information terminal displaying an inquiry about a trouble of a product and outputs said answer data indicating an answer to said inquiry;
a inquiry database which stores a plurality of trouble data and a plurality of answer data, wherein each of said plurality of trouble data is related to at least one of said plurality of answer data; and
a diagnosis data distributor which retrieves one indicating said trouble among said plurality of trouble data, based on said answer data and said plurality of answer data, and outputs said first information terminal.

6. The product inquiry apparatus according to claim 5, further comprising:
a diagnosis data collector which receives a diagnosis trouble data indicative of an content of said repair from a second information terminal receiving and displaying said trouble data and outputting said diagnosis trouble data after repairing said product based on said trouble data, relates said diagnosis trouble data to said answer data, and stores said diagnosis trouble data and answer data as one of said plurality of trouble data and one of said plurality of answer data respectively in said inquiry database.

7. The product inquiry apparatus according to claim 6, wherein said plurality of trouble data is related to a number of times that each kind of said plurality of trouble data is stored in said inquiry database.

8. The product inquiry apparatus according to claim 7, wherein said answer data indicates an answer to a question of said inquiry including a kind of said product,
said diagnosis data distributor outputs a similar trouble data as said trouble data to said first information terminal when said inquiry database does not store any one of said plurality of trouble data corresponding to said answer data, and
said similar trouble data is for another kind of a product similar to a kind of said product, and is related to a similar answer data corresponding to said answer data.

9. The product inquiry apparatus according to claim 7, further comprising:
a diagnosing unit which presumes a cause of said trouble in said product based on said answer data and generates a presumption trouble data;
wherein said diagnosis data distributor outputs said presumption trouble data to said first information terminal when said inquiry database does not store any one of said plurality of trouble data corresponding to said answer data.

10. The product inquiry apparatus according to claim 7, further comprising:
An inquiry unit which prepares a question of said inquiry and outputs said question to said first information terminal.

11. The product inquiry apparatus according to claim 10, further comprising:
a trouble content distributor which outputs one of said plurality of trouble data as a cause of said trouble to a third information terminal , when said cause of said trouble is stored beyond a predetermined frequency;
wherein said third information terminal receives and displays said cause of said trouble.

12. The product inquiry apparatus according to claim 11, wherein said product is a car.

13. A product inquiry method comprising the steps of:
(a) receiving an answer data from a first information terminal which displays an inquiry about a trouble of a product and outputs said answer data indicating an answer to said inquiry;
(b) retrieving a trouble data indicating said trouble among a plurality of trouble data, based on said answer data and a plurality of answer data; and
(c) outputting said trouble data to said first information terminal);
wherein said plurality of trouble data and a plurality of answer data is stored in an inquiry database, each of said plurality of trouble data is related to at least one of said plurality of answer data.

14. The product inquiry method according to claim 13, further comprising the steps of:
(d) receiving a diagnosis trouble data from a second information terminal which receives and displays said trouble data and outputs said diagnosis trouble data indicating an content of said repair after repairing said product based on said trouble data; and
(e) relating said diagnosis trouble data to said answer data and storing said diagnosis trouble data and answer data as one of said plurality of trouble data and one of said plurality of answer data, respectively in said inquiry database.

15. The product inquiry method according to claim 14, wherein said plurality of trouble data is related to a number of times that each kind of said plurality of trouble data is stored in said inquiry database.

16. The product inquiry method according to claim 15, further comprising the step of:
(f) outputting a similar trouble data as said trouble data to said first information terminal when said inquiry database does not store any one of said plurality of trouble data corresponding to said answer data;
wherein said answer data indicates an answer to a question of said inquiry including a kind of said product, and
said similar trouble data is for another kind of a product similar to a kind of said product, and is related to a similar answer data corresponding to said answer data.

17. The product inquiry method according to claim 15, further comprising the step of:
(g) presuming a cause of said trouble in said product based on said answer data and generating a presumption trouble data; and
(h) outputting said presumption trouble data to said first information terminal when said inquiry database does not store any one of said plurality of trouble data corresponding to said answer data.

18. The product inquiry method according to claim 15, further comprising the step of:
(i) preparing a question of said inquiry and outputting said question to said first information terminal.

19. The product inquiry method according to claim 18, further comprising the step of:
(j) outputting one of said plurality of trouble data as said cause of said trouble to a third information terminal, when said cause of said trouble is stored beyond a predetermined frequency;
wherein said third information terminal receives and displays said cause of said trouble.

20. The product inquiry method according to claim 19, wherein said product is a car.

21. A computer program product embodied on a computer-readable medium and comprising code that, when executed, causes a computer to perform the following:
(k) receiving an answer data from a first information terminal which displays an inquiry about a trouble of a product and outputs said answer data indicating an answer to said inquiry;
(l) retrieving a trouble data indicating said trouble among a plurality of trouble data, based on said answer data and a plurality of answer data; and
(m) outputting said trouble data to said first information terminal;
wherein said plurality of trouble data and a plurality of answer data is stored in an inquiry database, each of said plurality of trouble data is related to at least one of said plurality of answer data.

22. The computer program product according to claim 21, further comprising the steps of:
(n) receiving a diagnosis trouble data from a second information terminal which receives and displays said trouble data and outputs said diagnosis trouble data indicating an content of said repair after repairing said product based on said trouble data; and
(o) relating said diagnosis trouble data to said answer data and storing said diagnosis trouble data and answer data as one of said plurality of trouble data and one of said plurality of answer data, respectively in said inquiry database.

23. The computer program product according to claim 22, wherein said plurality of trouble data is related to a number of times that each kind of said plurality of trouble data is stored in said inquiry database.

24. The computer program product according to claim 23, further comprising the step of:
(p) outputting a similar trouble data as said trouble data to said first information terminal when said inquiry database does not store any one of said plurality of trouble data corresponding to said answer data;
wherein said answer data indicates an answer to a question of said inquiry including a kind of said product, and
said similar trouble data is for another kind of a product similar to a kind of said product, and is related to a similar answer data corresponding to said answer data.

25. The computer program product according to claim 23, further comprising the step of:
(q) presuming a cause of said trouble in said product based on said answer data and generating a presumption trouble data; and
(r) outputting said presumption trouble data to said first information terminal when said inquiry database does not store any one of said plurality of trouble data corresponding to said answer data.

26. The computer program product according to claim 23, further comprising the step of:
(s) preparing a question of said inquiry and outputting said question to said first information terminal.

27. The computer program product according to claim 26, further comprising the step of:
(t) outputting one of said plurality of trouble data as said cause of said trouble to a third information terminal , when said cause of said trouble is stored beyond a predetermined frequency;
wherein said third information terminal receives and displays said cause of said trouble.

28. The computer program product according to claim 27, wherein said product is a car.
